(19) United States
(12) Patent Application Publication
(10) Pub. No.: US 2026/0242918 A1
(43) Pub. Date: Aug. 20, 2026

(54) HOT-DIP PLATED STEEL SHEET

(71) Applicant: NIPPON STEEL CORPORATION, Tokyo (JP)

(72) Inventors: Tetsuya TOBA, Tokyo (JP); Yasuaki KAWAMURA, Tokyo (JP); Yuki OBARA, Tokyo (JP); Shigeru HASHIMOTO, Tokyo (JP); Shintaro UEMURA, Tokyo (JP); Jun NAKAGAWA, Tokyo (JP); Tomohito TANAKA, Tokyo (JP); Yusuke KOHIGASHI, Tokyo (JP)

(73) Assignee: NIPPON STEEL CORPORATION, Tokyo (JP)

(21) Appl. No.: 19/161,055

(22) PCT Filed: Oct. 3, 2023
(86) PCT No.: PCT/JP2023/036059

§ 371 Date: Aug. 29, 2025

(30) Foreign Application Priority Data
Mar. 30, 2023 (JP) 2023-054635

(51) Int. Cl. C23C 2/06; C22C 18/04; C23C 2/00

(52) U.S. Cl. CPC C23C 2/06; C22C 18/04; C23C 2/0062

(57) ABSTRACT

This hot-dip plated steel sheet includes: a steel sheet; and a hot-dip plating layer formed on a surface of the steel sheet, wherein the hot-dip plating layer contains Al: 0.1 to 70 mass % and Mg: 0.1 to 10.0 mass % in terms of average composition, and a remainder includes Zn and impurities, a pattern part arranged to have a predetermined shape and a non-pattern part are formed on at least one surface side of the steel sheet among the hot-dip plating layers, and an area fraction of an Mg₂Zn₁₁ phase on a surface of the non-pattern part is more than 0%, and a ratio (pattern part/non-pattern part) of an area fraction of an Mg₂Zn₁₁ phase on a surface of the pattern part to the area fraction of the Mg₂Zn₁₁ phase on the surface of the non-pattern part is in a range of 0 or more and less than 0.90 or in a range of 1.10 or more.

### TECHNICAL FIELD

The present invention relates to a hot-dip plated steel sheet.

Priority is claimed on Japanese Patent Application No. 2023-054635, filed Mar. 30, 2023, the content of which is incorporated herein by reference.

### BACKGROUND ART

Zn—Al—Mg-based hot-dip plated steel sheets, having higher corrosion resistance than hot-dip galvanized steel sheets, are widely used in various manufacturing industries such as building materials, home electric appliances, and automobile fields, and the use amount thereof has increased in recent years.

By the way, in order to show characters, patterns, design drawings, or the like on the surface of a hot-dip plating layer of a hot-dip plated steel sheet, the hot-dip plating layer may be subjected to steps such as printing or painting to show characters, patterns, design drawings, or the like on the surface of the hot-dip plating layer.

However, there is a problem that the cost and time increase to apply characters, designs, and the like when the hot-dip plating layer is subjected to steps such as printing or painting. Further, when characters, designs, and the like are shown on the surface of the plating layer by printing or painting, not only the metallic luster external appearance, which is highly supported by consumers, is lost, but also, due to the problem that the coating film itself is degraded with time and the adhesion of the coating film is degraded with time, the durability is poor, and the characters, designs, and the like may disappear over time. In addition, when characters, designs, and the like are shown on the surface of the plating layer by stamping an ink, cost and time are relatively suppressed, but there is a concern that corrosion resistance of the hot-dip plating layer may be reduced by the ink. Further, when a design or the like is shown by grinding the hot-dip plating layer, the durability of the design or the like is excellent, but since the thickness of the hot-dip plating layer at the ground location is greatly reduced, corrosion resistance is necessarily reduced, and there is a concern that plating characteristics are deteriorated.

Therefore, as disclosed in Patent Document 1 below, a technique has been proposed in which characters, designs, and the like are shown on the surface of the plating layer of a Zn—Al—Mg-based hot-dip plated steel sheet regardless of ink application or grinding processing.

### CITATION LIST

### Patent Document

Patent Document 1: Japanese Patent No. 6648871

### SUMMARY OF INVENTION

### Technical Problem

In the Zn—Al—Mg-based hot-dip plated steel sheet described in Patent Document 1, a pattern part having a predetermined shape is formed by controlling the exposure proportion of the Al phase on the surface of the plating layer or controlling the surface roughness Ra on the surface of the plating layer by performing hot-dip plating after attaching a solidification nucleus to the original plating sheet, and further improvement of the pattern part has been studied.

The present invention has been made in view of the above circumstances, and an object is to provide a hot-dip plated steel sheet having an improved pattern part.

### Solution to Problem

In order to achieve the above object, the present invention adopts the constitutions described below.
[1] A hot-dip plated steel sheet including:
   a steel sheet; and
   a hot-dip plating layer formed on a surface of the steel sheet,
   wherein
   the hot-dip plating layer contains Al: 0.1 to 70 mass % and Mg: 0.1 to 10.0 mass % in terms of average composition, and a remainder includes Zn and impurities,
   a pattern part arranged to have a predetermined shape and a non-pattern part are formed on at least one surface side of the steel sheet among the hot-dip plating layers, and
   an area fraction of an Mg₂Zn₁₁ phase on a surface of the non-pattern part is more than 0%, and a ratio (pattern part/non-pattern part) of an area fraction of an Mg₂Zn₁₁ phase on a surface of the pattern part to the area fraction of the Mg₂Zn₁₁ phase on the surface of the non-pattern part is in a range of 0 or more and less than 0.90 or in a range of 1.10 or more.
[2] A hot-dip plated steel sheet including:
   a steel sheet; and
   a hot-dip plating layer formed on a surface of the steel sheet,
   wherein
   the hot-dip plating layer contains Al: 0.1 to 70 mass % and Mg: 0.1 to 10.0 mass % in terms of average composition, and a remainder includes Zn and impurities,
   a pattern part arranged to have a predetermined shape and a non-pattern part are formed on at least one surface side of the steel sheet among the hot-dip plating layers, and
   a difference between an area fraction of an Mg₂Zn₁₁ phase on a surface of the pattern part and an area fraction of an Mg₂Zn₁₁ phase on a surface of the non-pattern part is 5% or more.
[3] A hot-dip plated steel sheet including:
   a steel sheet; and
   a hot-dip plating layer formed on a surface of the steel sheet,
   wherein
   the hot-dip plating layer contains Al: 0.1 to 70 mass % and Mg: 0.1 to 10.0 mass % in terms of average composition, and a remainder includes Zn and impurities,
   a pattern part arranged to have a predetermined shape and a non-pattern part are formed on at least one surface side of the steel sheet among the hot-dip plating layers,
   only one of the pattern part and the non-pattern part includes an Mg₂Zn₁₁ phase, and
   an area fraction of the Mg₂Zn₁₁ phase on a surface of the pattern part or a surface of the non-pattern part is 1% or more.
[4] The hot-dip plated steel sheet according to any one of [1] to [3], wherein the hot-dip plating layer further contains one or two selected from the group consisting of following group A and group B.
[Group A] Si: 0.0001 to 2.0 mass %
[Group B] 0.0001 to 2.0 mass % in total of one or two or more of Ni, Ti, Zr, Sr, Fe, Sb, Pb, Sn, Ca, Co, Mn, P, B, Bi, Cr, Sc, Y, REM, Hf, and C
[5] The hot-dip plated steel sheet according to any one of [1] to [3], wherein the pattern part is arranged in a shape that is any one, or a combination of two or more, of a straight line portion, a curved portion, a dot portion, a figure, a number, a symbol, a pattern, and a character.
[6] The hot-dip plated steel sheet according to [4], wherein the pattern part is arranged in a shape that is any one, or a combination of two or more, of a straight line portion, a curved portion, a dot portion, a figure, a number, a symbol, a pattern, and a character.
[7] The hot-dip plated steel sheet according to any one of [1] to [3], wherein an area of one continuous pattern part is 1 mm² or more.
[8] The hot-dip plated steel sheet according to [4], wherein an area of one continuous pattern part is 1 mm² or more.
[9] The hot-dip plated steel sheet according to any one of [1] to [3], wherein the pattern part is arranged in a shape that is any one, or a combination of two or more, of a straight line portion, a curved portion, a dot portion, a figure, a number, a symbol, a pattern, and a character, and an area of one continuous pattern part is 1 mm² or more.
[10] The hot-dip plated steel sheet according to [4], wherein the pattern part is arranged in a shape that is any one, or a combination of two or more, of a straight line portion, a curved portion, a dot portion, a figure, a number, a symbol, a pattern, and a character, and an area of one continuous pattern part is 1 mm² or more.
[11] The hot-dip plated steel sheet according to any one of [1] to [3], wherein an coating mass of the hot-dip plating layer is 30 to 600 g/m² in a total of both surfaces of the steel sheet.
[12] The hot-dip plated steel sheet according to [4], wherein the hot-dip plating layer has an average composition containing the group A in terms of mass %.
[13] The hot-dip plated steel sheet according to [4], wherein the hot-dip plating layer has an average composition containing the group B in terms of mass %.
[14] The hot-dip plated steel sheet according to any one of [1] to [3], wherein the Mg₂Zn₁₁ phase is contained in the hot-dip plating layer as one or both of a massive [Mg₂Zn₁₁ phase] and an [Al/Zn/Mg₂Zn₁₁ phase ternary eutectic structure].
[15] The hot-dip plated steel sheet according to any one of [1] to [3], wherein a difference between a static friction coefficient of the pattern part and a static friction coefficient of the non-pattern part is less than 0.2.

### Advantageous Effects of Invention

According to the present invention, it is possible to provide a hot-dip plated steel sheet having an improved pattern part.

### BRIEF DESCRIPTION OF DRAWINGS

FIG. 1 A schematic diagram illustrating a wavy line-shaped pattern formed on a hot-dip plating layer of an example.

### DESCRIPTION OF EMBODIMENTS

The hot-dip plated steel sheet of an embodiment of the present invention will be described.

The hot-dip plated steel sheet of the present embodiment is a hot-dip plated steel sheet including: a steel sheet; and a hot-dip plating layer formed on a surface of the steel sheet, wherein the hot-dip plating layer contains Al: 0.1 to 70 mass % and Mg: 0.1 to 10.0 mass % in terms of average composition, and a remainder includes Zn and impurities, a pattern part arranged to have a predetermined shape and a non-pattern part are formed on at least one surface side of the steel sheet among the hot-dip plating layers, and an area fraction of an Mg₂Zn₁₁ phase on a surface of the non-pattern part is more than 0%, and a ratio (pattern part/non-pattern part) of an area fraction of an Mg₂Zn₁₁ phase on a surface of the pattern part to the area fraction of the Mg₂Zn₁₁ phase on the surface of the non-pattern part is in a range of 0 or more and less than 0.90 or in a range of 1.10 or more.

The hot-dip plated steel sheet of the present embodiment is a hot-dip plated steel sheet including: a steel sheet; and a hot-dip plating layer formed on a surface of the steel sheet, wherein the hot-dip plating layer contains Al: 0.1 to 70 mass % and Mg: 0.1 to 10.0 mass % in terms of average composition, and a remainder includes Zn and impurities, a pattern part arranged to have a predetermined shape and a non-pattern part are formed on at least one surface side of the steel sheet among the hot-dip plating layers, and a difference between an area fraction of an Mg₂Zn₁₁ phase on a surface of the pattern part and an area fraction of an Mg₂Zn₁₁ phase on a surface of the non-pattern part is 5% or more.

The hot-dip plated steel sheet of the present embodiment is a hot-dip plated steel sheet including: a steel sheet; and a hot-dip plating layer formed on a surface of the steel sheet, wherein the hot-dip plating layer contains Al: 0.1 to 70 mass % and Mg: 0.1 to 10.0 mass % in terms of average composition, and a remainder includes Zn and impurities, a pattern part arranged to have a predetermined shape and a non-pattern part are formed on at least one surface side of the steel sheet among the hot-dip plating layers, only one of the pattern part and the non-pattern part includes an Mg₂Zn₁₁ phase, and
an area fraction of the Mg₂Zn₁₁ phase on a surface of the pattern part or a surface of the non-pattern part is 1% or more.

The material of the steel sheet as the base of the hot-dip plating layer is not particularly limited. Although details will be described below, general steel or the like can be used as the material without particular limitation, Al killed steel or some high alloy steel can also be applied, and the shape is also not particularly limited. The hot-dip plating layer according to the present embodiment is formed by applying the hot-dip plating method described below to the steel sheet. The hot-dip plating layer is formed on the surface of the steel sheet. That is, the hot-dip plating layer is formed on both one surface and the other surface of the steel sheet.

Next, the chemical composition of the hot-dip plating layer will be described.

The hot-dip plating layer contains Al: 0.1 to 70 mass % and Mg: 0.1 to 10.0 mass % in terms of average composition, and includes Zn and impurities as the remainder. More preferably, the hot-dip plating layer contains Al: 0.1 to 70 mass % and Mg: 0.1 to 10.0 mass % in terms of average composition, and includes Zn and impurities as the remainder.

Further, the hot-dip plating layer may contain one or two selected from the group consisting of group A and group B described below.
[Group A] Si: 0.0001 to 2 mass %
[Group B] 0.0001 to 2 mass % in total of one or two or more of Ni, Ti, Zr, Sr, Fe, Sb, Pb, Sn, Ca, Co, Mn, P, B, Bi, Cr, Sc, Y, REM, Hf, and C

The content of Al is in the range of 0.1 to 70 mass % in terms of average composition. Al is preferably contained in order to ensure corrosion resistance. When the content of Al is 0.1 mass % or more in the hot-dip plating layer, the effect of improving corrosion resistance is further enhanced. When the content is more than 70 mass %, the effect of improving corrosion resistance is not only saturated, but also may be deteriorated. In addition, when Al is included in the range of 0.1 to 70 mass %, an Mg₂Zn₁₁ phase can be formed. From the viewpoint of corrosion resistance, the content is preferably 0.5 to 55 mass %. The content is more preferably 1 to 30 mass %.

The content of Mg is in the range of 0.1 to 10.0 mass % in terms of average composition. Mg is preferably contained in order to improve corrosion resistance. When the content of Mg is 0.1 mass % or more in the hot-dip plating layer, the effect of improving corrosion resistance is further enhanced. However, when Mg exceeds 10.0 mass %, dross occurs significantly in the plating bath so that corrosion resistance decreases, and thus the content of Mg is 10.0 mass % or less. In addition, when Mg is included in the range of 0.1 to 10.0 mass %, an Mg₂Zn₁₁ phase can be formed. From the viewpoint of balance between corrosion resistance and the amount of formation of the Mg₂Zn₁₁ phase, the content of Mg is preferably 0.5 to 10.0 mass %. The content is more preferably in the range of 1 to 8.0 mass %.

The hot-dip plating layer may contain 0.0001 to 2.0 mass % of Si in terms of average composition.

Si is an element effectively improving the adhesion of the hot-dip plating layer. When Si is contained in an amount of 0.0001 mass % or more in the hot-dip plating layer, the effect of improving adhesion is exhibited, and therefore, Si is preferably contained in an amount of 0.0001 mass % or more. On the other hand, even when Si is contained in an amount of more than 2.0 mass %, the effect of improving plating adhesion is saturated, and therefore, the content of Si is 2.0 mass % or less even when the hot-dip plating layer contains Si. From the viewpoint of plating adhesion, the content of Si may be 0.0010 to 1.0 mass %, or may be 0.0100 to 0.8 mass % in the hot-dip plating layer.

The hot-dip plating layer may contain 0.0001 to 2.0 mass % in total of one or two or more of Ni, Ti, Zr, Sr, Fe, Sb, Pb, Sn, Ca, Co, Mn, P, B, Bi, Cr, Sc, Y, REM, Hf, and C in terms of average composition. When these elements are contained, the corrosion resistance of the hot-dip plating layer can be further improved. REM is one or two or more of rare earth elements with atomic numbers 57 to 71 in the periodic table.

The remainder of the chemical composition of the hot-dip plating layer includes zinc and impurities. The impurities are other than zinc, and are inevitably included in the base metal, or included when steel is melted in a plating bath.

Note that the average composition of the hot-dip plating layer can be measured by the following method. The average composition can be obtained such that first, the surface layer coating film is removed with a coating film-peeling agent that does not erode the plating (for example, NEOLIVER SP-751, manufactured by SANSAIKAKO); then the hot-dip plating layer is dissolved with hydrochloric acid containing an inhibitor (for example, HIBIRON, manufactured by Sugimura Chemical Industrial Co., Ltd.); and the resulting solution is subjected to inductively coupled plasma (ICP) emission spectrometry. In addition, when there is no surface layer coating film, the work of removing the surface layer coating film can be omitted.

Next, the microstructure of the hot-dip plating layer will be described. The hot-dip plating layer of the present embodiment may have a microstructure as described below, for example, when the hot-dip plating layer contains Al: 4 to 22 mass %, Mg: 1 to 10.0 mass %, and 0 to 2 mass % of Si in terms of average composition. As a result, the external appearance of the surface of the hot-dip plating layer becomes mat finish, that is, an external appearance in which fine irregularities are uniformly formed, and the external appearance has excellent aesthetic appearance as a whole. Note that the microstructure of the hot-dip plating layer described below can be obtained as long as the plating has the above chemical composition, and therefore, in the present invention, there is no need to limit the microstructure of the hot-dip plating layer.

The hot-dip plating layer containing Al, Mg, and Zn includes an [Al phase], an [Al/Zn/MgZn₂ ternary eutectic structure], and an Mg₂Zn₁₁ phase. The Mg₂Zn₁₁ phase may be included as a massive [Mg₂Zn₁₁ phase] or as an [Al/Zn/Mg₂Zn₁₁ ternary eutectic structure]. Further, the hot-dip plating layer may include an [MgZn₂ phase] or [Zn phase]. In addition, when Si is contained in the hot-dip plating layer, an [Mg₂Si phase] may be included.

### [Al/Zn/MgZn₂ Ternary Eutectic Structure]

The [Al/Zn/MgZn₂ ternary eutectic structure] is a ternary eutectic structure of an Al phase, a Zn phase, and an intermetallic compound MgZn₂ phase, and the Al phase forming the ternary eutectic structure corresponds to, for example, an “Al″ phase” (which is an Al solid solution in which Zn is solid-dissolved and includes a small amount of Mg) at a high temperature in an Al—Zn—Mg ternary equilibrium phase diagram.

The Al″ phase at a high temperature usually appears separated into a fine Al phase and a fine Zn phase at normal temperature. The Zn phase in the ternary eutectic structure is a Zn solid solution in which a small amount of Al is solid-dissolved, and in some cases, further a small amount of Mg is solid-dissolved. The MgZn₂ phase in the ternary eutectic structure is an intermetallic compound phase present in the vicinity of Zn: about 84 mass % in a Zn—Mg binary equilibrium phase diagram.

As seen in the phase diagram, it is considered that another additive element is not solid-dissolved in each phase, or even if an additive element is solid-dissolved, the amount of the additive element is extremely small. However, since the amount thereof cannot be clearly distinguished by an ordinary analysis, the ternary eutectic structure formed of these three phases is represented by an [Al/Zn/MgZn₂ ternary eutectic structure] in the present specification.

### [Al Phase]

The [Al phase] is a phase that looks like an island with a clear boundary in the base of the ternary eutectic structure described above, and for example, the phase corresponds to the “Al″ phase” (which is an Al solid solution in which Zn is solid-dissolved and includes a small amount of Mg) at a high temperature in an Al—Zn—Mg ternary equilibrium phase diagram. In the Al″ phase at a high temperature, the amount of Zn and the amount of Mg to be solid-dissolved differ depending on the Al and Mg concentrations in the plating bath. The Al″ phase at a high temperature is usually separated into a fine Al phase and a fine Zn phase at normal temperature, but the island-like shape observed at normal temperature is considered to be attributed to the shape of the Al″ phase at a high temperature.

As seen in the phase diagram, it is considered that another additive element is not solid-dissolved in this phase, or even if an additive element is solid-dissolved, the amount of the additive element is extremely small. However, since the amount thereof cannot be clearly distinguished by ordinary analysis, the phase that is derived from the Al″ phase at high temperatures and has a shape attributed to the shape of the Al″ phase is referred to as the [Al phase] in the present specification.

The [Al phase] can be clearly distinguished from the Al phase forming the ternary eutectic structure described above in microscopic observation.

Mg₂Zn₁₁ Phase ([Mg₂Zn₁₁ Phase], [Al/Zn/Mg₂Zn₁₁ Ternary Eutectic Structure])

The Mg₂Zn₁₁ phase is included as an [Mg₂Zn₁₁ phase] or an [Al/Zn/Mg₂Zn₁₁ ternary eutectic structure]. The hot-dip plating layer may include both the [Mg₂Zn₁₁ phase] and the [Al/Zn/Mg₂Zn₁₁ ternary eutectic structure]. When the Mg₂Zn₁₁ phase is included in one or both of the pattern part and the non-pattern part at a predetermined area fraction, the visibility of the pattern part is improved. The Mg₂Zn₁₁ phase will be described in detail in the description of the pattern part and the non-pattern part below.

[Al/Zn/Mg₂Zn₁₁ Ternary Eutectic Structure]

The [Al/Zn/Mg₂Zn₁₁ ternary eutectic structure] is a ternary eutectic structure of an Al phase, a Zn phase, and an intermetallic compound Mg₂Zn₁₁ phase, and the Al phase forming the ternary eutectic structure corresponds to, for example, an “Al″ phase” (which is an Al solid solution in which Zn is solid-dissolved and includes a small amount of Mg) at a high temperature in an Al—Zn—Mg ternary equilibrium phase diagram.

The Al″ phase at a high temperature usually appears separated into a fine Al phase and a fine Zn phase at normal temperature. The Zn phase in the ternary eutectic structure is a Zn solid solution in which a small amount of Al is solid-dissolved, and in some cases, further a small amount of Mg is solid-dissolved. The Mg₂Zn₁₁ phase in the ternary eutectic structure is an intermetallic compound phase present in the vicinity of Zn: about 94 mass % in a Zn—Mg binary equilibrium phase diagram.

As seen in the phase diagram, it is considered that another additive element is not solid-dissolved in each phase, or even if an additive element is solid-dissolved, the amount of the additive element is extremely small. However, since the amount thereof cannot be clearly distinguished by an ordinary analysis, the ternary eutectic structure formed of these three phases is represented by an [Al/Zn/Mg₂Zn₁₁ ternary eutectic structure] in the present specification.

[Mg₂Zn₁₁ Phase]

The [Mg₂Zn₁₁ phase] is a phase that looks like an island with a clear boundary in the base of the [Al/Zn/MgZn₂ ternary eutectic structure] or [Al/Zn/Mg₂Zn₁₁ ternary eutectic structure], and in practice, a small amount of Al may be solid-dissolved. As seen in the phase diagram, it is considered that another additive element is not solid-dissolved in this phase, or even if an additive element is solid-dissolved, the amount of the additive element is extremely small.

The [Mg₂Zn₁₁ phase] and the Mg₂Zn₁₁ phase forming the [Al/Zn/Mg₂Zn₁₁ ternary eutectic structure] can be clearly distinguished from each other by microscopic observation. The hot-dip plating layer according to the present embodiment may not include [Mg₂Zn₁₁ phase] depending on the manufacturing conditions, but it is included in the hot-dip plating layer under most manufacturing conditions.

### [Zn Phase]

The [Zn phase] is a phase that looks like an island with a clear boundary in the base of the [Al/Zn/MgZn₂ ternary eutectic structure] or [Al/Zn/Mg₂Zn₁₁ ternary eutectic structure], and in practice, a small amount of Al or a small amount of Mg may be solid-dissolved. As seen in the phase diagram, it is considered that another additive element is not solid-dissolved in this phase, or even if an additive element is solid-dissolved, the amount of the additive element is extremely small.

The [Zn phase] and the Zn phase forming the [Al/Zn/MgZn₂ ternary eutectic structure] or the [Al/Zn/Mg₂Zn₁₁ ternary eutectic structure] can be clearly distinguished from each other by microscopic observation. The hot-dip plating layer according to the present embodiment may include the [Zn phase] depending on manufacturing conditions, but, the effect of the [Zn phase] on the corrosion resistance was hardly observed. Therefore, even if the [Zn phase] is included in the hot-dip plating layer, there is no particular problem.

### [MgZn₂ Phase]

The [MgZn₂ phase] is a phase that looks like an island with a clear boundary in the base of the [Al/Zn/MgZn₂ ternary eutectic structure] or [Al/Zn/Mg₂Zn₁₁ ternary eutectic structure], and in practice, a small amount of Al may be solid-dissolved. As seen in the phase diagram, it is considered that another additive element is not solid-dissolved in this phase, or even if an additive element is solid-dissolved, the amount of the additive element is extremely small.

The [MgZn₂ phase] and the MgZn₂ phase forming the [Al/Zn/MgZn₂ ternary eutectic structure] can be clearly distinguished from each other by microscopic observation. The hot-dip plating layer according to the present embodiment may not include the [MgZn₂ phase] depending on the manufacturing conditions, but it is included in the hot-dip plating layer under most manufacturing conditions.

### [Mg₂Si Phase]

The [Mg₂Si phase] is a phase that looks like an island with a clear boundary in the solidified microstructure of the plating layer to which Si is added. As seen in the phase diagram, it is considered that Zn, Al, or another additive element is not solid-dissolved in the [Mg₂Si phase], or even if it is solid-dissolved, the amount of thereof is extremely small. The [Mg₂Si phase] can be clearly distinguished from other phases in the hot-dip plating layer by microscopic observation,

The hot-dip plating layer of the present embodiment is formed such that the steel sheet is immersed in a plating bath and then pulled up and thereafter the molten metal adhering on the sheet surface is solidified. As a result, the [Al phase], the Mg₂Zn₁₁ phase, the [Al/Zn/MgZn₂ ternary eutectic structure], and the like are formed. Depending on the chemical composition of the hot-dip plating layer (that is, the chemical composition of the plating bath), the [Mg₂Si phase], the [MgZn₂ phase], or the [Zn phase] may be formed in the base of the [Al/Zn/MgZn₂ ternary eutectic structure]. In addition, the [Al/Zn/Mg₂Zn₁₁ ternary eutectic structure] may be formed.

Next, the pattern part and the non-pattern part in the surface of the hot-dip plating layer will be described.

In the hot-dip plating layer of the present embodiment, the pattern part arranged to have the predetermined shape and the non-pattern part are formed. One of the pattern part and the non-pattern part includes a region having a relatively low metallic luster on the surface and showing white or gray. Such a region is a region having fine irregularities on the surface observed in the Zn—Al—Mg-based hot-dip plated steel sheet and having low smoothness, and has a mat external appearance. Therefore, the pattern part and the non-pattern part can be visually distinguished with the naked eye, under a magnifying glass, or under a microscope. The pattern part is preferably arranged in a shape that is any one, or a combination of two or more, of a straight line portion, a curved portion, a dot portion, a figure, a number, a symbol, a pattern, and a character. In addition, the shape of the pattern part may be arranged in a disordered manner. In addition, the non-pattern part is the region other than the pattern part. In addition, the shape of the pattern part is allowed as long as it can be recognized as a whole even if part of the pattern part is missing like a dead pixel. In addition, the non-pattern part may have a shape that borders the boundary of the pattern part.

Note that it is sufficient if the pattern part and the non-pattern part are formed on the surface of one of the hot-dip plating layers formed on the one surface side and the other surface side of the steel sheet. In this case, the pattern part is not formed on the surface of the hot-dip plating layer on the other side, and it is sufficient if there is a non-pattern part.

In addition, the pattern part and the non-pattern part may be formed on the surfaces of the hot-dip plating layers on both the one side and the other side among the hot-dip plating layers formed on the one surface side and the other surface side of the steel sheet.

When the surface of the hot-dip plating layer is arranged with a shape that is any one, or a combination of two or more, of a straight line portion, a curved portion, a dot portion, a figure, a number, a symbol, a pattern, and a character, the region can be the pattern part, and the other region can be the non-pattern part.

The pattern part is preferably formed in such a size that the presence of the pattern part can be determined with the naked eye, under a magnifying glass, or under a microscope. In addition, the non-pattern part is a region occupying most of the hot-dip plating layer (the surface of the hot-dip plating layer), and the pattern part may be arranged in the non-pattern part.

The pattern part is arranged in a predetermined shape in the non-pattern part. Specifically, the pattern part is arranged in the non-pattern part in a shape that is any one, or a combination of two or more, of a straight line portion, a curved portion, a figure, a dot portion, a figure, a number, a symbol, a pattern, and a character. By intentionally adjusting the shape of the pattern part, the surface of the hot-dip plating layer shows a shape that is any one, or a combination of two or more, of a straight line portion, a curved portion, a figure, a dot portion, a figure, a number, a symbol, a pattern, and a character. For example, the surface of the hot-dip plating layer shows a character string, a numeric string, a symbol, a mark, a line drawing, a design drawing, a combination thereof, or the like, each of which includes the pattern part. This shape is a shape intentionally or artificially formed by the manufacturing method described below, and is not formed naturally. Accordingly, the area of one continuous pattern part is larger than what is naturally formed. It is sufficient if the area of one continuous pattern part has a size that can be distinguished from the surrounding non-pattern part. The area of one continuous pattern part is particularly preferably 1 mm² or more because the area of one continuous pattern part can be distinguished from the surrounding non-pattern part with the naked eye or under a magnifying glass without using a microscope as the area is larger.

As described above, one of the pattern part and the non-pattern part includes a region having a relatively low metallic luster on the surface and showing white or gray. Such a region is a region having fine irregularities on the surface observed in the Zn—Al—Mg-based hot-dip plated steel sheet and having low smoothness, and has a mat external appearance. Hereinafter, such a region is referred to as a mat external appearance region.

In addition, the other of the pattern part and the non-pattern part is a region having a relatively high surface smoothness and showing darker gray or black than a region having a mat external appearance. Hereinafter, such a region is referred to as a discolored region.

Due to such a difference in external appearance, the pattern part and the non-pattern part can be identified with the naked eye.

The pattern part and the non-pattern part can be distinguished under a microscope. Specifically, the shape constituted by the pattern part can be identified under a microscope even in a field of view of 50 times or less due to a difference in a surface state thereof. Since the pattern part and the non-pattern part of the present embodiment have shapes formed by the manufacturing method described below, the area of one continuous pattern part is larger than what is naturally formed. Therefore, the pattern part and the non-pattern part can be identified under a microscope in a field of view of preferably 20 times or less, more preferably 10 times or less, and more preferably 5 times or less.

Next, a difference in metallographic structure between the pattern part and the pattern part will be described in detail. In the following description, as an example, a case where the non-pattern part is a mat external appearance region and the pattern part is a discolored region will be described.

The discolored region constituting the pattern part has a higher area fraction of the Mg₂Zn₁₁ phase in the metallographic structure than the mat external appearance region constituting the non-pattern part. That is, the region having a relatively large amount of the Mg₂Zn₁₁ phase appears dark gray to black as compared with the region having a small amount of the Mg₂Zn₁₁ phase or the region not including the Mg₂Zn₁₁ phase. In order to clearly distinguish the pattern part and the non-pattern part with the naked eye or the like, the area fraction of the Mg₂Zn₁₁ phase in the metallographic structure preferably has at least one of the constitutions (a) to (c) described below. Two or more of the constitutions (a) to (c) may be included, or all of the constitutions (a) to (c) may be included.
(a) The area fraction of the Mg₂Zn₁₁ phase on the surface of the non-pattern part is more than 0%, and the ratio (pattern part/non-pattern part) of the area fraction of the Mg₂Zn₁₁ phase on the surface of the pattern part to the area fraction of the Mg₂Zn₁₁ phase on the surface of the non-pattern part is in the range of 0 to 0.90 or in the range of 1.10 or more.
(b) The difference between the area fraction of the Mg₂Zn₁₁ phase on the surface of the pattern part and the area fraction of the Mg₂Zn₁₁ phase on the surface of the non-pattern part is 5% or more.
(c) Only one of the pattern part and the non-pattern part includes the Mg₂Zn₁₁ phase, and the area fraction of the Mg₂Zn₁₁ phase on the surface of the pattern part or the surface of the non-pattern part is 1% or more.

### Regarding (a)

As the proportion of the Mg₂Zn₁₁ phase in the metallographic structure of the plating layer increases, the external appearance of the plating layer shows darker gray or black. Accordingly, when the ratio (pattern part/non-pattern part) of the area fraction of the Mg₂Zn₁₁ phase on the surface of the pattern part to the area fraction of the Mg₂Zn₁₁ phase on the surface of the non-pattern part is in the range of 0 to less than 0.90 or 1.10 or more, the difference in color between the pattern part and the non-pattern part on the surface of the plating layer becomes clear, and the pattern part and the non-pattern part can be identified with the naked eye, under a magnifying glass, or under a microscope. However, when the area fraction ratio (pattern part/non-pattern part) is 0.90 or more to less than 1.10, the color difference between the pattern part and the non-pattern part becomes unclear, and it becomes difficult to identify the pattern part. In addition, the upper limit of the area fraction ratio (pattern part/non-pattern part) does not need to be particularly defined.

### Regarding (b)

As the proportion of the Mg₂Zn₁₁ phase in the metallographic structure of the plating layer increases, the external appearance of the plating layer shows darker gray or black. Accordingly, in a case where the Mg₂Zn₁₁ phase is included in only one of the pattern part and the non-pattern part, or in a case where the Mg₂Zn₁₁ phase is included in both the pattern part and the non-pattern part, when the difference between the area fraction of the Mg₂Zn₁₁ phase on the surface of the pattern part and the area fraction of the Mg₂Zn₁₁ phase on the surface of the non-pattern part is 5% or more, the color difference between the pattern part and the non-pattern part on the surface of the plating layer becomes clear, and the pattern part and the non-pattern part can be identified with the naked eye, under a magnifying glass, or under a microscope. The difference in area fraction of the Mg₂Zn₁₁ phase may be 10% or more or 15% or more. In addition, the upper limit of the difference in area fraction is not particularly limited, but may be, for example, 50% or less.

### Regarding (c)

As the proportion of the Mg₂Zn₁₁ phase in the metallographic structure of the plating layer increases, the external appearance of the plating layer shows darker gray or black. Accordingly, when only one of the pattern part and the non-pattern part includes the Mg₂Zn₁₁ phase and the area fraction of the Mg₂Zn₁₁ phase on the surface of the pattern part or the surface of the non-pattern part is 1% or more, the color difference between the pattern part and the non-pattern part on the surface of the plating layer becomes clear, and the pattern part and the non-pattern part can be identified with the naked eye, under a magnifying glass, or under a microscope. The area fraction of the Mg₂Zn₁₁ phase may be 5% or more or 10% or more. In addition, the upper limit of the area fraction is not particularly limited, but may be, for example, 50% or less.

The area fraction of the Mg₂Zn₁₁ phase included in the pattern part and the non-pattern part is determined in the manner described below. First, the boundary between the pattern part and the non-pattern part is specified by observing the surface of the hot-dip plating layer with the naked eye. When it is difficult to specify the boundary with the naked eye, an enlarged image of a magnifying glass or an optical microscope is used.

Next, the surface of the hot-dip plating layer formed on the steel sheet is ground from the surface to a depth of 0.1 μm by mirror polishing to remove a native oxide film on the surface. The native oxide film is removed in each of the pattern part and the non-pattern part.

Next, a reflected electron image of the surface of the hot-dip plating layer from which the native oxide film has been removed is captured by a scanning electron microscope (SEM) to specify the Mg₂Zn₁₁ phase. The Mg₂Zn₁₁ phase present in a massive state and present as an [Al/Zn/Mg₂Zn₁₁ ternary eutectic structure] is specified. When the Mg₂Zn₁₁ phase is specified, an elemental analysis by an energy dispersive X-ray elemental analyzer attached to the SEM is used in combination, and the Mg₂Zn₁₁ phase is specified while the distributions of Zn, Al, and Mg are checked. Then, the total area fraction of the Mg₂Zn₁₁ phase in the observed visual field is determined. The observed visual field is a region of 0.2 mm² or more.

As described above, the area fraction of the Mg₂Zn₁₁ phase included in the pattern part and the non-pattern part is determined. Further, the area fraction ratio (proportion of area fraction of Mg₂Zn₁₁ phase in pattern part to area fraction of Mg₂Zn phase in non-pattern part (pattern part/non-pattern part)) is determined. Further, the difference between the area fraction of the Mg₂Zn₁₁ phase in the pattern part and the area fraction of the Mg₂Zn₁₁ phase in the non-pattern part is determined.

It is preferable that the surface of the plating layer of the pattern part and the surface of the plating layer of the non-pattern part have the same static friction coefficient. Specifically, the difference in static friction coefficient of the surface of the plating layer between the pattern part and the non-pattern part is preferably less than 0.2. The difference in static friction coefficient of the surface of the plating layer between the pattern part and the non-pattern part is more preferably less than 0.1.

When the difference in static friction coefficient between the surface of the plating layer of the pattern part and the surface of the plating layer of the non-pattern part is within the above range, partial deterioration of corrosion resistance can be prevented.

The method for measuring the static friction coefficient can be performed using, for example, the method described below.

A hot-dip plated steel sheet is cut to prepare a rectangular sheet-shaped test piece having a width of 150 mm, a length of 100 mm, and a thickness of 0.6 mm and a disk-shaped test piece having a diameter of 20 mm and a thickness of 0.6 mm. However, when the length in the sheet width direction of the region to which the water flow is sprayed is less than 20 mm, for example, a disk-shaped test piece having a diameter of the length is collected. The disk-shaped test piece is arranged on the rectangular sheet-shaped test piece, and the surface of the plating layer of the rectangular sheet-shaped test piece and the surface of the plating layer of the disk-shaped test piece are brought into contact with each other. For example, a combination of the rectangular sheet-shaped test piece and the disk-shaped test piece may be a combination in which the rectangular sheet-shaped test piece and the disk-shaped test piece are placed with the sheet width directions coinciding with each other, and the sliding direction is the sheet passage direction. Further, a load (vertical load) is applied to the disk-shaped test piece downward from the above, and in a state where the disk-shaped test piece is pressed against the rectangular sheet-shaped test piece, a load (horizontal load) in a horizontal direction is applied to the rectangular sheet-shaped test piece, and the rectangular sheet-shaped test piece is slid with respect to the disk-shaped test piece. A value obtained by dividing the horizontal load when the rectangular sheet-shaped test piece first starts to move by the vertical load is defined as a static friction coefficient. Note that, as test conditions, the vertical load is 3.14 kN, the sliding speed of the rectangular sheet-shaped test piece is 150 mm/sec, and the sliding distance of the rectangular sheet-shaped test piece is 45 mm. Note that, in the above test, a high-load reciprocating friction wear tester is used.

Next, the method for manufacturing the hot-dip plated steel sheet of the present embodiment will be described.

In the hot-dip plated steel sheet of the present embodiment, a steel sheet manufactured through steelmaking, casting, and hot rolling is hot-dip plated. In addition, after the hot rolling described above, pickling, hot-band annealing, cold rolling, and cold-band annealing may be further performed, and then hot-dip plating may be performed. In addition, the hot-dip plating is a continuous hot-dip plating method in which a steel sheet is continuously passed through a hot-dip plating bath.

The hot-dip plating bath preferably contains Al: 0.1 to 70 mass % and Mg: 0.1 to 10.0 mass % and includes Zn and impurities as the remainder. In addition, the hot-dip plating bath may contain Al: 0.1 to 70 mass % and Mg: 0.1 to 10.0 mass %, and include the remainder including Zn and impurities. Furthermore, the hot-dip plating bath may contain Si: 0.0001 to 2 mass %, and may contain 0.0001 to 2 mass % in total of one or two or more of Ni, Ti, Zr, Sr, Fe, Sb, Pb, Sn, Ca, Co, Mn, P, B, Bi, Cr, Sc, Y, REM, Hf, and C. Note that the average composition of the hot-dip plating layer of the present embodiment is substantially the same as the composition of the hot-dip plating bath.

The temperature of the hot-dip plating bath varies depending on the composition, but is preferably, for example, in a range of 400 to 500° C. This is because a desired hot-dip plating layer can be formed when the hot-dip plating bath has a temperature in this range.

In addition, it is sufficient if the coating mass of the hot-dip plating layer is adjusted by means such as gas wiping on the steel sheet pulled up from the hot-dip plating bath. The coating mass of the hot-dip plating layer is preferably adjusted so that the total coating mass of both surfaces of the steel sheet falls within a range of 30 to 600 g/m². When the coating mass is less than 30 g/m², the corrosion resistance of the hot-dip plated steel sheet is deteriorated, which is not preferable. It is not preferable that the coating mass exceeds 600 g/m² because a molten metal adhered to the steel sheet drips, and the surface of the hot-dip plating layer cannot be made smooth. The coating mass on one surface is in the range of 15 to 300 g/m².

After the coating mass is adjusted by the gas wiping, the pattern part and the non-pattern part are formed. In the formation of the pattern part, the pattern part, and the formation of the non-pattern part, a water flow is locally sprayed against the metal in the molten state while the entire steel sheet is cooled. The water flow spray position is preferably moved continuously so as to trace the shape of the pattern part to be formed. The position of the water flow nozzle is preferably fixed and the spray position is preferably changed by changing the angle of the water flow nozzle and the pressure of the water flow to enable high speed writing. The pattern part is formed on the locus of the sprayed water flow. It is not preferable to only spray mist-like water because the cooling effect is lower than that of the water flow. When the amount of the water flow is excessive, there is a possibility that the pattern part and the non-pattern part are not formed because a portion where the heat is not sufficiently recovered as described below is generated in the sprayed region. The appropriate amount of water flow varies depending on the sheet thickness of the hot-dip plated steel sheet or the like, and therefore is preferably adjusted experimentally. When the water flow is continuously sprayed, the amount of the water flow tends to be excessive, so that the water flow is preferably sprayed in a pulse form. In addition, although it is conceivable to spray a cooling gas, gas spraying is not preferable because it has a lower heat removal effect than the water flow and is not sufficient as a means for increasing the existence rate of the Mg₂Zn₁₁ phase.

In order to form the pattern part into a predetermined shape, the substantially entire hot-dip plating layer is cooled at an average cooling rate of 10° C./sec or more from a bath temperature to 345° C. in order to form the non-pattern part. Then, in order to form the pattern part, the water flow is sprayed to part of the hot-dip plating layer while the plating layer temperature is in the range of 360° C. to 345° C. When the plating layer temperature is higher than 360° C., the plating layer is not sufficiently solidified. When the water flow is sprayed in a state in which the plating layer is not sufficiently solidified, the surface of the plating layer is wavy, and when the plating layer is solidified in that state, irregularities are generated. It is known that the static friction coefficient is higher in the region where the irregularities are generated than in the surroundings, Additionally, when the water flow is sprayed at a plating layer temperature of higher than 360° C., the Mg₂Zn₁₁ phase does not crystallize on the surface of the plating layer. When the Mg₂Zn₁₁ phase does not crystallize on the surface of the plating layer of the pattern part, the difference in external appearance between the pattern part and the non-pattern part does not sufficiently appear. Therefore, it is necessary to spray the water flow at a plating layer temperature of 360° C. or lower. When the water flow is sprayed at 360° C. or lower, irregularities are not formed on the surface of the plating layer, uniformity of the thickness of the plating layer is maintained, and corrosion resistance is not partially deteriorated. In addition, by spraying the water flow at 345° C. or higher, the crystallization amount of the Mg₂Zn₁₁ phase can be controlled. Here, the plating layer temperature refers to the surface temperature of the plating layer. The surface temperature of the plating layer can be measured by a radiation thermometer or a contact thermometer.

By spraying the water flow, the temperature of the hot-dip plating layer is locally lowered. Thereafter, heat flows in from a portion to which the water flow is not sprayed, so that heat is recovered, and the temperature of the plating layer rises. By this series of temperature changes, the existence rate of the Mg₂Zn₁₁ phase increases, and a pattern part is formed.

As described above, the generation of irregularities on the surface of the plating layer can be prevented by spraying the water flow at a predetermined temperature. Therefore, the surface of the plating layer of the pattern part and the surface of the plating layer of the non-pattern part can have the same static friction coefficient.

Further, when a chemical conversion treatment layer is formed on the surface of the hot-dip plating layer, the hot-dip plated steel sheet after the hot-dip plating layer is formed is subjected to chemical conversion treatment. The type of the chemical conversion treatment is not particularly limited, and known chemical conversion treatment can be used.

In addition, when a coating film layer is formed on the surface of the hot-dip plating layer or the surface of the chemical conversion treatment layer, the hot-dip plated steel sheet after the hot-dip plating layer is formed or after the chemical conversion treatment layer is formed is subjected to a coating treatment. The type of the coating treatment is not particularly limited, and a known coating treatment can be used.

### EXAMPLES

Next, examples of the present invention will be described. The steel sheet after cold rolling was degreased and rinsed in water, and annealed at a soaking temperature of 800° C. for a soaking time of 1 minute under an inert atmosphere. Subsequently, the steel sheet was immersed in a plating bath and then pulled up, and the entire plating layer was cooled at an average cooling rate of 10° C./sec or more from a bath temperature to 345° C. while the coating mass of the plating layer was controlled and the pattern part was formed. In this way, hot-dip plated steel sheets of Nos. 1 to 18 and 21 to 45 shown in Tables 1 to 6 were manufactured.

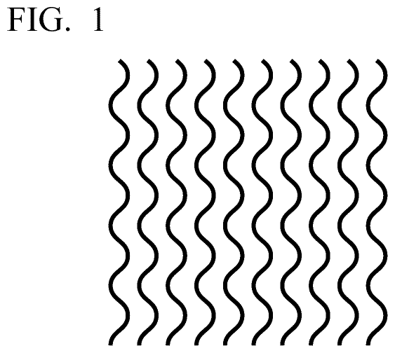

The pattern part was formed such that the water flow was sprayed to part of the hot-dip plating layer while the plating layer temperature was in the range of 360° C. to 345° C. As a water flow spraying pattern, wavy line-shaped patterns at intervals of 50 mm were formed. FIG. 1 illustrates a wavy line-shaped pattern. The wavy line-shaped pattern is a pattern in which a plurality of wavy lines is arranged at equal intervals, and the interval between the wavy lines is 50 mm.

In addition, Zn—Al—Mg-based hot-dip plated steel sheets of Nos. 19 and 20 were manufactured in the same manner as described above except that in the formation of the pattern part, the water flow was sprayed to part of the hot-dip plating layer at a plating layer temperature of higher than 360° C. or lower than 345° C.

In addition, Zn—Al—Mg-based hot-dip plated steel sheets of Nos. 46 to 48 were manufactured in the same manner as described above except that the formation of the pattern part was attempted by mist ejection instead of water flow ejection.

In addition, a hot-dip plated steel sheet was manufactured in the same manner as described above except that the formation of the pattern part was not performed. A wavy line-shaped pattern at intervals of 50 mm was printed on the surface of the hot-dip plating layer of the steel sheet by an inkjet method. The shape of the pattern is as illustrated in FIG. 1. In this way, a Zn—Al—Mg-based hot-dip plated steel sheet of No. 49 was manufactured.

In addition, a hot-dip plated steel sheet was manufactured in the same manner as described above except that the formation of the pattern part was not performed. Thereafter, the surface of the hot-dip plating layer was ground to form a wavy line-shaped pattern at intervals of 50 mm. The shape of the pattern is as illustrated in FIG. 1. In this way, a hot-dip plated steel sheet of No. 50 was manufactured.

For the obtained hot-dip plated steel sheet, the area fraction of the Mg₂Zn₁₁ phase included in the pattern part and the non-pattern part was determined. First, the boundary between the pattern part and the non-pattern part was specified by observing the surface of the hot-dip plating layer with the naked eye. When it is difficult to specify the boundary with the naked eye, an enlarged image of a magnifying glass or an optical microscope was used.

Next, the surface of the hot-dip plating layer formed on the steel sheet was ground from the surface to a depth of 0.1 μm by mirror polishing to remove a native oxide film on the surface. The native oxide film was removed in each of the pattern part and the non-pattern part.

Next, a reflected electron image of the surface of the hot-dip plating layer from which the native oxide film has been removed was captured by a scanning electron microscope (SEM) to specify the Mg₂Zn₁₁ phase. The Mg₂Zn₁₁ phase present in a massive state and present as an [Al/Zn/Mg₂Zn₁₁ ternary eutectic structure] was specified. When the Mg₂Zn₁₁ phase was specified, an elemental analysis by an energy dispersive X-ray elemental analyzer attached to the SEM was used in combination, and the Mg₂Zn₁₁ phase was specified while the distributions of Zn, Al, and Mg were checked. Then, the total area fraction of the Mg₂Zn₁₁ phase in the observed visual field was determined. The observed visual field was set to 0.2 mm². Then, the total area fraction of the Mg₂Zn₁₁ phase in the observed visual field was determined.

As described above, the area fraction of the Mg₂Zn₁₁ phase included in the pattern part and the non-pattern part was determined. In addition, the area fraction ratio (proportion of area fraction of Mg₂Zn₁₁ phase in pattern part to area fraction of Mg₂Zn₁₁ phase in non-pattern part (pattern part/non-pattern part)) of the Mg₂Zn₁₁ phase was determined. Further, the difference between the area fraction of the Mg₂Zn₁₁ phase in the pattern part and the area fraction of the Mg₂Zn₁₁ phase in the non-pattern part was determined.

### [Distinguishability]

A test sheet provided with the pattern part in an initial state immediately after manufacture and a test sheet with the pattern part in an aged state after outdoor exposure for 6 months were visually evaluated based on the criteria described below. In both the initial state and the aged state, AA to B were evaluated as acceptable.
AA: The pattern part can be visually recognized even from 5 m ahead.
A: The pattern part cannot be visually recognized from 5 m ahead, but the visibility from 3 m ahead is high.
B: The pattern part cannot be visually recognized from 3 m ahead, but the visibility from 1 m ahead is high.
C: The pattern part cannot be visually recognized from 1 m ahead.

### [Corrosion Resistance]

The test sheet was cut into 150×70 mm, and subjected to a corrosion acceleration test CCT in accordance with JASO-M609 for 30 cycles. Thereafter, the rust generation state was investigated and evaluated based on the criteria described below. AA to B were evaluated as acceptable,
AA: No rust is generated, and a beautiful design external appearance is maintained in both the pattern part and the non-pattern part.
A: Rust was not generated, but a slight change in design external appearance was recognized in the pattern part and the non-pattern part.
B: There is slight rust generation, and the design external appearance is slightly impaired, but the pattern part and the non-pattern part can be visually distinguished.
C: There is rust generation, and the pattern part and the non-pattern part were significantly deteriorated in external appearance quality, and cannot be visually distinguished.

[Static friction coefficient] A hot-dip plated steel sheet was cut to prepare a rectangular sheet-shaped test piece having a width of 150 mm, a length of 100 mm, and a thickness of 0.6 mm and a disk-shaped test piece having a diameter of 20 mm and a thickness of 0.6 mm. The disk-shaped test piece was arranged on the rectangular sheet-shaped test piece, and the surface of the plating layer of the rectangular sheet-shaped test piece and the surface of the plating layer of the disk-shaped test piece were brought into contact with each other and slid to measure the static friction coefficient.

The static friction coefficient between the pattern part and the non-pattern part was measured, and the difference in static friction coefficient between the pattern part and the non-pattern part was evaluated based on the criteria described below.
AA: Difference in static friction coefficient between the pattern part and the non-pattern part is less than 0.1
A; Difference in static friction coefficient between the pattern part and the non-pattern part is 0.1 or more and less than 0.2
B: Difference in static friction coefficient between the pattern part and the non-pattern part is 0.2 or more and less than 0.3
C: Difference in static friction coefficient between the pattern part and the non-pattern part is 0.3 or more

As shown in Tables 1 to 6, in the Zn—Al—Mg-based hot-dip plated steel sheets of Nos. 1 to 9, 12 to 16, and 21 to 45, the chemical compositions of the hot-dip plating layers were within the scope of the present invention, and the pattern parts were formed by water flow ejection after the steel sheets were pulled up from the plating bath, so that the pattern parts and the non-pattern parts were formed in the hot-dip plating layers. Then, the ratio of the area fractions of the Mg₂Zn₁₁ phases on the surfaces of the pattern part and the non-pattern part (pattern part/non-pattern part) was 0 or more and less than 0.90 or 1.10 or more, the difference between the area fraction of the Mg₂Zn₁₁ phase in the pattern part and the area fraction of the Mg₂Zn₁₁ phase in the non-pattern portion was 5% or more, or the Mg₂Zn₁₁ phase was included only in one of the pattern part and the non-pattern part, and the area fraction of the Mg₂Zn₁₁ phase in the pattern part or the non-pattern part was 1% or more. Therefore, Nos. 1 to 9, 12 to 16, and 21 to 45 were excellent in both distinguishability and corrosion resistance.

In the hot-dip plated steel sheet of No. 10, since Al was not included in the hot-dip plating layer, corrosion resistance was deteriorated.

In the hot-dip plated steel sheet of No. 11, since the Al content of the hot-dip plating layer was excessive, corrosion resistance was deteriorated.

In the hot-dip plated steel sheet of No. 17, since Mg was not included in the hot-dip plating layer, the Mg₂Zn₁₁ phase was not formed, and it was difficult to distinguish between the pattern part and the non-pattern part.

In the hot-dip plated steel sheet of No. 18, since the Mg content of the hot-dip plating layer was excessive, corrosion resistance was deteriorated.

The hot-dip plated steel sheets of Nos. 19 and 20 had inferior distinguishability because the condition for forming the pattern part was out of the preferable range. In the hot-dip plated steel sheet of No. 19, the temperature of the plating layer when the water flow was sprayed was low, so that the Mg₂Zn₁₁ phase was not crystallized. In addition, in the hot-dip plated steel sheet of No. 20, since the temperature of the plating layer when the water flow was sprayed was high, irregularities were formed on the surface of the plating layer, and a portion where the thickness of the plating layer was thin was generated, and therefore corrosion resistance was deteriorated.

In the hot-dip plated steel sheets of Nos. 46 to 48, the formation of the pattern part was attempted not by the water flow but by the mist ejection. Therefore, the ratio of the area fractions of the Mg₂Zn₁₁ phases on the surfaces of the pattern part and the non-pattern part (pattern part/non-pattern part) was 0.90 or more and less than 1.10, the difference between the area fraction of the Mg₂Zn₁₁ phase in the pattern part and the area fraction of the Mg₂Zn₁₁ phase in the non-pattern part was less than 5%, and further, since the Mg₂Zn₁₁ phase was included in both the pattern part and the non-pattern part, the distinguishability was inferior.

In No. 49, in which a square pattern part was printed by an inkjet method, the pattern part was thinned due to outdoor exposure for 6 months, and the distinguishability was deteriorated.

In No. 50, in which a square pattern was formed by grinding, the thickness of the plating layer at the ground location was reduced, and corrosion resistance at the ground location was deteriorated.

TABLE 1

| | Manufacturing method | | Hot-dip plating layer | | | | |
|---|---|---|---|---|---|---|---|
| | | Plating layer temperature at | Average composition | | Remainder: Zn and | | |
| | | time of water flow ejection | (mass %) | | impurities | | Coating mass of plating |
| No. | Method | (° C.) | AI | Mg | Si | Other | (both surfaces) (g/m²) |
| 1 | Water flow ejection | 355 | 0.1 | 3.0 | — | — | 30 |
| 2 | Water flow ejection | 360 | 0.5 | 3.0 | 0.0001 | — | 250 |
| 3 | Water flow ejection | 360 | 1 | :3.0 | 0.2 | — | 230 |
| 4 | Water flow ejection | 345 | 6 | 3.0 | 0.2 | — | 300 |
| 5 | Water flow ejection | 360 | 11 | 3,0 | 0.2 | — | 310 |
| 6 | Water flow ejection | 355 | 19 | 6.0 | 0.2 | — | 420 |
| 7 | Water flow ejection | 350 | 30 | 3.0 | 1.0 | — | 390 |
| 8 | Water flow ejection | 350 | 55 | 2.0 | 1.6 | — | 220 |
| 9 | Water flow ejection | .355 | 70 | 3.0 | 2.0 | — | 200 |
| 10 | Water flow ejection | 355 | 1 | 3.0 | — | — | 360 |
| 11 | Water flow ejection | 355 | 75 | 3.0 | 2.0 | — | 370 |
| 12 | Water flow ejection | 355 | 11 | 0.1 | 0.001 | — | 40 |
| 13 | Water flow ejection | 360 | 11 | 0.5 | 0.01 | — | 400 |
| 14 | Water flow ejection | 350 | 11 | 1.0 | 0.2 | — | 430 |
| 15 | Water flow ejection | 350 | 11 | 8.0 | 0.8 | — | 300 |
| 16 | Water flow ejection | 360 | 11 | 10.0 | 1.0 | — | 600 |
| 17 | Water flow ejection | 350 | 11 | — | — | — | 410 |
| 18 | Water flow ejection | 350 | 11 | 11.0 | — | — | 400 |
| 19 | Water flow ejection | 320 | 11 | 3.0 | 0.2 | — | 330 |
| 20 | Water flow ejection | 370 | 11 | 3.0 | 0.2 | — | 270 |
| 21 | Water flow ejection | 355 | 11 | 3.0 | 0.2 | Ni0.01% | 310 |
| 22 | Water flow ejection | 345 | 11 | 3.0 | 0.2 | Ti0.01% | 280 |
| 23 | Water flow ejection | 360 | 11 | 3.0 | 0.2 | Zr0.01% | 210 |
| 24. | Water flow ejection | 350 | 11 | 3.0 | 0.2 | Sr0.01% | 210 |
| 25 | Water flow ejection | 345 | 11 | :3.0 | 0.2 | Fe0.01% | 250 |

The underlined parts indicate that they are outside the scope of the present invention or outside the range of preferred manufacturing conditions.

TABLE 2

| | Manufacturing method | | Hot-dip plating layer | | | | |
|---|---|---|---|---|---|---|---|
| | | Plating layer temperature at | Average composition | | Remainder: Zn and | | |
| | | time of water flow ejection | (mass %) | | impurities | | Coating mass of plating |
| No. | Method | (° C.) | AI | Mg | Si | Other | (both surfaces) (g/m²) |
| 26 | Water flow ejection | 345 | 11 | 3.0 | 0.2 | Sb0.01% | 240 |
| 27 | Water flow ejection | 360 | 11 | 3.0 | 0.2 | Pb0.01% | 330 |
| 28 | Water flow ejection | 345 | 11 | 3.0 | 0.2 | Sn0.01% | 330 |
| 29 | Water flow ejection | 355 | 11 | 3.0 | 0.2 | Ca0.01% | 190 |
| 30 | Water flow ejection | 345 | 11 | 3.0 | 0.2 | Co0.01% | 300 |
| 31 | Water flow ejection | 360 | 11 | 3.0 | 0.2 | Mn0.01% | 420 |
| 32 | Water flow ejection | 345 | 11 | 3.0 | 0.2 | P0.01% | 430 |
| 33 | Water flow ejection | 345 | 11 | 3.0 | 0.2 | B0.01% | 390 |
| 34 | Water flow ejection | 355 | 11 | 3,0 | 0.2 | B10.01% | 240 |
| 35 | Water flow ejection | 350 | 11 | 3.0 | 0.2 | Cr0.01% | 240 |
| 36 | Water flow ejection | 355 | 11 | 3.0 | 0.2 | Sc0.01% | 180 |
| 37 | Water flow ejection | 345 | 11 | 3.0 | 0.2 | Y0.01% | 260 |
| 38 | Water flow ejection | 355 | 11 | 3,0 | 0.2 | REM0.01% | 380 |
| 39 | Water flow ejection | 360 | 11 | 3.0 | 0.2 | Hf0.01% | 280 |
| 40 | Water flow ejection | 355 | 11 | 3.0 | 0.2 | C0.01% | 230 |
| 41 | Water flow ejection | 350 | 11 | 3.0 | — | Ni0.01% | 260 |
| 42 | Water flow ejection | 355 | 11 | 3.0 | — | Ti0.01% | 180 |
| 43 | Water flow ejection | 360 | 11 | 3.0 | — | Zr0.01% | 440 |
| 44 | Water flow ejection | 345 | 11 | 3.0 | — | Sr0.01% | 250 |
| 45 | Water flow ejection | 355 | 11 | 3.0 | 0.2 | Ti0.01%+Mn0.01% | 300 |
| 46 | Mist ejection | 360 | 11 | 3.0 | 0.2 | — | 330 |
| 47 | Mist ejection | 345 | 11 | 3.0 | 0.2 | — | 370 |
| 48 | Mist ejection | 355 | 11 | 3.0 | 0.2 | — | 180 |
| 49 | Printing after plating | — | 11 | 3.0 | 0.2 | — | 450 |
| 50 | Grinding after plating | — | 11 | 3.0 | 0.2 | — | 370 |

The underlined parts indicate that they are outside the scope of the present invention or outside the range of preferred manufacturing conditions.

TABLE 3

| | Hot-dip plating layer | | | |
|---|---|---|---|---|
| | | | Area fraction | |
| | Area fraction of Mg₂Zn₁₁ phase | | ratio | Area fraction |
| | Pattern | Non-pattern | Pattern part/ | difference |
| No. | part (%) | part (%) | non-pattern part | % |
| 1 | 25 | 10 | 2.50 | 15 |
| 2 | 40 | 15 | 2.67 | 25 |
| 3 | 35 | 20 | 1.75 | 15 |
| 4 | 35 | 5 | 7.00 | 30 |
| 5 | 20 | 0 | — | 20 |
| 6 | 30 | 10 | 3.00 | 20 |
| 7 | 30 | 5 | 6.00 | 25 |
| 8 | 20 | 10 | 2.00 | 10 |
| 9 | 45 | 40 | 1.13 | 5 |
| 10 | 40 | 20 | 2.00 | 20 |
| 11 | 40 | 30 | 1.33 | 10 |
| 12 | 1 | 0 | — | 1 |
| 13 | 5 | 0 | — | 5 |
| 14 | 20 | 5 | 4.00 | 15 |
| 15 | 50 | 30 | 1.67 | 20 |
| 16 | 40 | 45 | 0.89 | 5 |
| 17 | 0 | 0 | — | 0 |
| 18 | 20 | 40 | 0.50 | 20 |
| 19 | 0 | 0 | — | 0 |
| 20 | 0 | 0 | — | 0 |
| 21 | 30 | 20 | 1.50 | 10 |
| 22 | 20 | 10 | 2.00 | 10 |
| 23 | 20 | 30 | 0.67 | 10 |
| 24 | 30 | 10 | 3.00 | 20 |
| 25 | 20 | 0 | — | 20 |

The underlined parts indicate that they are outside the scope of the present invention.

TABLE 4

| | Hot-dip plating layer | | | |
|---|---|---|---|---|
| | | | Area fraction | |
| | Area fraction of Mg₂Zn₁₁ phase | | ratio | Area fraction |
| | Pattern | Non-pattern | Pattern part/ | difference |
| No. | part (%) | part (%) | non-pattern part | % |
| 26 | 45 | 20 | 2.25 | 25 |
| 27 | 25 | 15 | 1.67 | 10 |
| 28 | 30 | 15 | 2.00 | 15 |
| 29 | 25 | 35 | 0.71 | 10 |
| 30 | 45 | 35 | 1.29 | 10 |
| 31 | 45 | 35 | 1.29 | 10 |
| 32 | 0 | 10 | 0.00 | 10 |
| 33 | 25 | 5 | 5.00 | 20 |
| 34 | 25 | 5 | 5.00 | 20 |
| 35 | 10 | 0 | — | 10 |
| 36 | 35 | 10 | 3.50 | 25 |
| 37 | 30 | 20 | 1.50 | 10 |
| 38 | 20 | 5 | 4.00 | 15 |
| 39 | 15 | 0 | — | 15 |
| 40 | 35 | 25 | 1.40 | 10 |
| 41 | 35 | 20 | 1.75 | 15 |
| 42 | 20 | 10 | 2.00 | 10 |
| 43 | 15 | 5 | 3.00 | 10 |
| 44 | 35 | 15 | 2.33 | 20 |
| 45 | 30 | 15 | 2.00 | 15 |
| 46 | 60 | 63 | 0.95 | 3 |
| 47 | 55 | 53 | 1.04 | 2 |
| 48 | 30 | 33 | 0.91 | 3 |
| 49 | — | — | — | — |
| 50 | — | — | — | — |

The underlined parts indicate that they are outside the scope of the present invention.

TABLE 5

| | Evaluation | | | | | |
|---|---|---|---|---|---|---|
| | Distinguishability | | Corrosion | Static friction | | |
| No. | Initial state | Aged state | resistance | coefficient difference | | Remarks |
| 1 | AA | AA | B | AA | 0.05 | Inventive example |
| 2 | AA | AA | A | AA | 0.02 | Inventive example |
| 3 | AA | AA | AA | AA | 0.09 | Inventive example |
| 4 | AA | AA | AA | AA | 0.06 | Inventive example |
| 5 | AA | AA | AA | AA | 0.07 | Inventive example |
| 6 | AA | AA | AA | AA | :0.03 | Inventive example |
| 7 | AA | AA | AA | AA | 0.04 | Inventive example |
| 8 | AA | AA | AA | AA | 0.07 | Inventive example |
| 9 | A | A | B | AA | 0.06 | Inventive example |
| 10 | AA | AA | C | B | 0.25 | Comparative example |
| 11 | AA | AA | C | AA | 0.02 | Comparative example |
| 12 | B | B | B | AA | 0.05 | Inventive example |
| 13 | AA | AA | A | AA | 0.05 | Inventive example |
| 14 | AA | AA | AA | AA | 0.06 | Inventive example |
| 15 | AA | AA | A | AA | 0.09 | Inventive example |
| 16 | B | B | B | AA | 0.01 | Inventive example |
| 17 | C | C | C | AA | 0.03 | Comparative example |
| 18 | AA | AA | C | AA | 0.07 | Comparative example |
| 19 | C | C | AA | AA | 0.05 | Comparative example |
| 20 | C | C: | C | C | 0.32 | Comparative example |
| 21 | AA | AA | AA | AA | 0.03 | Inventive example |
| 22 | AA | AA | AA | AA | 0.09 | Inventive example |
| 23 | AA | AA | AA | AA | 0.06 | Inventive example |
| 24 | AA | AA | AA | AA | 0.06 | Inventive example |
| 25 | AA | AA | AA | AA | 0.09 | Inventive example |

TABLE 6

| | Evaluation | | | | | |
|---|---|---|---|---|---|---|
| | Distinguishability | | Corrosion | Static friction | | |
| No. | Initial state | Aged state® | resistance | coefficient difference | | Remarks |
| 26 | AA | AA | AA | AA | 0.09 | Inventive example |
| 27 | AA | AA | AA | AA | 0.03 | Inventive example |
| 28 | AA | AA | AA | AA | 0.06 | Inventive example |
| 29 | AA | AA | AA | AA | 0.01 | Inventive example |
| 30 | AA | AA | AA | AA | 0.03 | Inventive example |
| 31 | AA | AA | AA | AA | 0.04 | Inventive example |
| 32 | AA | AA | AA | AA | 0.01 | Inventive example |
| 33 | AA | AA | AA | AA | 0.05 | Inventive example |
| 34 | AA | AA | AA | AA | 0.06 | Inventive example |
| 35 | AA | AA | AA | AA | 0.05 | Inventive example |
| 36 | AA | AA | AA | AA | 0.01 | Inventive example |
| 37 | AA | AA | AA | AA | 0.09 | Inventive example |
| 38 | AA | AA | AA | AA | 0.02 | Inventive example |
| 39 | AA | AA | AA | AA | 0.09 | Inventive example |
| 40 | AA | AA | AA | AA | 0.03 | Inventive example |
| 41 | AA | AA | AA | AA | 0.01 | Inventive example |
| 42 | AA | AA | AA | AA | 0.04 | Inventive example |
| 43 | AA | AA | AA | AA | 0:05 | Inventive example |
| 44 | AA | AA | AA | AA | 0.02 | Inventive example |
| 45 | AA | AA | AA | AA | 0.05 | Inventive example |
| 46 | C | C | AA | A | 0.16 | Comparative |
| | | | | | | example |
| 47 | C | C | AA | B | 0.28 | Comparative |
| | | | | | | example |
| 48 | C | C | AA | B | 0.23 | Comparative |
| | | | | | | example |
| 49 | AA | C | AA | A | 0.12 | Comparative |
| | | | | | | example |
| 50 | AA | AA | C | C | 0.36 | Comparative |
| | | | | | | example |

1. A hot-dip plated steel sheet comprising:
a steel sheet; and
a hot-dip plating layer formed on a surface of the steel sheet,
wherein
the hot-dip plating layer contains Al: 0.1 to 70 mass % and Mg: 0.1 to 10.0 mass % in terms of average composition, and a remainder includes Zn and impurities,
a pattern part arranged to have a predetermined shape and a non-pattern part are formed on at least one surface side of the steel sheet among the hot-dip plating layers, and
any of (a) to (c) below are satisfied,
(a) An area fraction of an Mg₂Zn₁₁ phase on a surface of the non-pattern part is more than 0%, and a ratio (pattern part/non-pattern part) of an area fraction of an Mg₂Zn₁₁ phase on a surface of the pattern part to the area fraction of the Mg₂Zn₁₁ phase on the surface of the non-pattern part is in a range of 0 or more and less than 0.90 or in a range of 1.10 or more,
(b) A difference between an area fraction of an Mg₂Zn₁₁ phase on a surface of the pattern part and an area fraction of an Mg₂Zn₁₁ phase on a surface of the non-pattern part is 5% or more,
(c) Only one of the pattern part and the non-pattern part includes an Mg₂Zn₁₁ phase, and
an area fraction of the Mg₂Zn₁₁ phase on a surface of the pattern part or a surface of the non-pattern part is 1% or more.

2. A hot-dip plated steel sheet according to claim 1, wherein (b) is satisfied.

3. A hot-dip plated steel sheet according to claim 1, wherein (c) is satisfied.

4. The hot-dip plated steel sheet according to claim 1, wherein the hot-dip plating layer further contains one or two of following group A and group B,
[Group A] Si: 0.0001 to 2.0 mass %
[Group B] 0.0001 to 2.0 mass % in total of one or two or more of Ni, Ti, Zr, Sr, Fe, Sb, Pb, Sn, Ca, Co, Mn, P, B, Bi, Cr, Sc, Y, REM, Hf, and C.

5. The hot-dip plated steel sheet according to claim 1, wherein the pattern part is arranged in a shape that is any one, or a combination of two or more, of a straight line portion, a curved portion, a dot portion, a figure, a number, a symbol, a pattern, and a character.

6. The hot-dip plated steel sheet according to claim 4, wherein the pattern part is arranged in a shape that is any one, or a combination of two or more, of a straight line portion, a curved portion, a dot portion, a figure, a number, a symbol, a pattern, and a character.

7. The hot-dip plated steel sheet according to claim 1, wherein an area of one continuous pattern part is 1 mm² or more.

8. The hot-dip plated steel sheet according to claim 4, wherein an area of one continuous pattern part is 1 mm² or more.

9. The hot-dip plated steel sheet according to claim 1, wherein
the pattern part is arranged in a shape that is any one, or a combination of two or more, of a straight line portion, a curved portion, a dot portion, a figure, a number, a symbol, a pattern, and a character, and
an area of one continuous pattern part is 1 mm² or more.

10. The hot-dip plated steel sheet according to claim 4, wherein
the pattern part is arranged in a shape that is any one, or a combination of two or more, of a straight line portion, a curved portion, a dot portion, a figure, a number, a symbol, a pattern, and a character, and
an area of one continuous pattern part is 1 mm² or more.

11. The hot-dip plated steel sheet according to claim 1, wherein a coating mass of the hot-dip plating layer is 30 to 600 g/m² in a total of both surfaces of the steel sheet.

12. The hot-dip plated steel sheet according to claim 4, wherein the hot-dip plating layer has an average composition containing the group A in terms of mass %.

13. The hot-dip plated steel sheet according to claim 4, wherein the hot-dip plating layer has an average composition containing the group B in terms of mass %.

14. The hot-dip plated steel sheet according to claim 1, wherein the Mg₂Zn₁₁ phase is contained in the hot-dip plating layer as one or both of a massive [Mg₂Zn₁₁ phase] and an [Al/Zn/Mg₂Zn₁₁ phase ternary eutectic structure].

15. The hot-dip plated steel sheet according to claim 1, wherein a difference between a static friction coefficient of the pattern part and a static friction coefficient of the non-pattern part is less than 0.2.

16. The hot-dip plated steel sheet according to claim 1, wherein (a) is satisfied.
